(19) United States
(12) Patent Application Publication
(10) Pub. No.: US 2011/0232605 A1
(43) Pub. Date: Sep. 29, 2011

(54) FUEL INJECTION CONTROL SYSTEM AND FUEL INJECTION CONTROL METHOD FOR SPARK-IGNITION INTERNAL COMBUSTION ENGINE

(75) Inventor: Takeshi Ashizawa, Kanagawa-ken (JP)

(73) Assignee: TOYOTA JIDOSHA KABUSHIKI KAISHA, Toyota-shi, Aichi-ken (JP)

(21) Appl. No.: 12/672,221

(22) PCT Filed: Aug. 8, 2008
(86) PCT No.: PCT/IB2008/002086

§ 371 Date: Feb. 4, 2010

(30) Foreign Application Priority Data
Aug. 9, 2007 (JP) 2007-207708

(51) Int. Cl. F02M 69/04

(52) U.S. Cl. 123/445

(57) ABSTRACT

In a fuel injection control system for an ignition-spark internal combustion engine, when a piston in a cylinder is stopped at a point after an opening timing of an intake valve, and before substantially 90 degrees after a top dead center of an intake stroke at a time of start of the internal combustion engine, fuel is injected for the cylinder a plurality of times during a period from the opening timing of the intake valve to substantially 90 degrees after the top dead center of the intake stroke.

### BACKGROUND OF THE INVENTION

1. Field of the Invention

The invention relates to a fuel injection control system and a fuel injection control method for a spark-ignition internal combustion engine.

2. Description of the Related Art

Recently, environmental concerns have received attention, and therefore, vehicles with an idling stop mechanism have been proposed in various manners to reduce exhaust gas and to improve fuel economy. For example, Japanese Patent Application Publication No. 2004-036561 (JP-A-2004-036561) describes an automatic stop-start apparatus for a direct-injection internal combustion engine for which an idling stop mechanism is provided. To ensure the start performance of the engine at a time of restart of the engine, the automatic stop-start apparatus executes a control so that fuel is injected into a cylinder in which a piston is in a compression stroke and a cylinder in which a piston is to enter the compression stroke next while the internal combustion engine is in a stopped state, and then, when a restart condition is satisfied, the fuel is injected into a cylinder in which a piston is in an intake stroke.

When the fuel is injected into the cylinder in which the piston is in the intake stroke to quickly start the engine, the fuel needs to be injected at the substantially same timing as the timing at which the rotation of the crankshaft of the engine starts. However, when employing an economy running system that frequently stops idling of the engine, an engine coolant temperature and an ambient temperature are often high at the time of start of the engine. A temperature of air is high particularly in the cylinder in which the piston is in the intake stroke at the time of start of the engine, because an exhaust stroke is not performed in the cylinder after the rotation of the crankshaft starts until the fuel injection is performed. As a result, abnormal combustion, such as pre-ignition, may be caused in the cylinder.

### SUMMARY OF THE INVENTION

The invention reduces the possibility of occurrence of abnormal combustion in an internal combustion engine that is quickly started in a high temperature condition.

A first aspect of the invention relates to a fuel injection control system for an ignition-spark internal combustion engine. In the fuel injection control system, when a piston in a cylinder is stopped at a point after an opening timing of an intake valve, and before substantially 90 degrees after a top dead center of an intake stroke at a time of start of the internal combustion engine, fuel is injected for the cylinder a plurality of times during a period from the opening timing of the intake valve to substantially 90 degrees after the top dead center of the intake stroke.

To more accurately execute a fuel injection control to reduce the possibility of occurrence of abnormal combustion, in the above-described aspect, when the piston in the cylinder is stopped at a point after the opening timing of the intake valve, and before substantially 90 degrees after the top dead center of the intake stroke at the time of start of the internal combustion engine, and it is estimated that a temperature in the cylinder is higher than a prescribed value, the fuel may be injected for the cylinder a plurality of times. Particularly when the internal combustion engine is controlled by an idling stop function; it may be estimated whether the temperature in the cylinder is higher than the prescribed value, using an elapsed time after the internal combustion engine is stopped until a restart condition is satisfied. Further, it may be estimated whether the temperature in the cylinder is higher than the prescribed value, using the elapsed time, an ambient temperature, and an engine coolant temperature.

Particularly when the fuel is injected to an intake port, the invention has significant advantageous effects.

A second aspect of the invention relates to a fuel injection control system for an ignition-spark internal combustion engine. The fuel injection control system includes: a stop point determination portion that determines whether a piston in a cylinder is stopped at a point after an opening timing of an intake valve, and before substantially 90 degrees after a top dead center of an intake stroke at a time of start of the internal combustion engine; and a fuel injection control portion that executes a fuel injection control so that fuel is injected for the cylinder a plurality of times, when the stop point determination portion determines that the piston in the cylinder is stopped at a point after the opening timing of the intake valve, and before substantially 90 degrees after the top dead center of the intake stroke at the time of start of the internal combustion engine.

A third aspect of the invention relates to a fuel injection control method for an ignition-spark internal combustion engine. The fuel injection control method includes: determining whether a piston in a cylinder is stopped at a point after an opening timing of an intake valve, and before substantially 90 degrees after a top dead center of an intake stroke at a time of start of the internal combustion engine; and executing a fuel injection control so that fuel is injected for the cylinder a plurality of times, when it is determined that the piston in the cylinder is stopped at a point after the opening timing of the intake valve, and before substantially 90 degrees after the top dead center of the intake stroke at the time of start of the internal combustion engine.

According to the above-described aspects, it is possible to reduce the possibility of occurrence of abnormal combustion in the internal combustion engine that is quickly started in a high temperature condition.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram schematically showing a configuration of an internal combustion engine according to an embodiment of the invention;

FIG. 2 is a timing chart showing fuel injection timings when the internal combustion engine is restarted after the internal combustion engine is stopped by an idling stop control; and

FIG. 3 is a flowchart of a fuel injection control process.

### DETAILED DESCRIPTION OF EMBODIMENTS

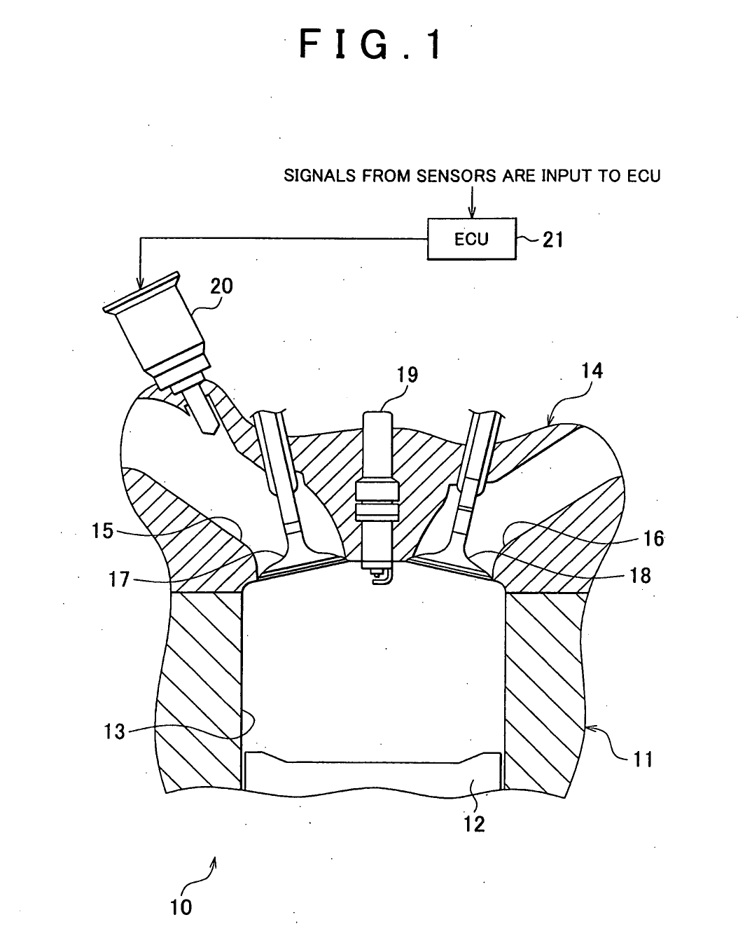

Hereinafter, an embodiment of the invention will be described with reference to the drawings. FIG. 1 is a block diagram schematically showing a configuration of an internal combustion engine in the embodiment of the invention. Although FIG. 1 is a schematic partial sectional view of only one cylinder, the internal combustion engine includes a plurality of cylinders as generally known. Also, the internal combustion engine is used, for example, in a vehicle with an idling stop function.

In a cylinder block 11 of the internal combustion engine 10, a plurality of cylinder bores 13 are provided. In each of the cylinder bores 13, a piston 12 is disposed. An upper portion of the cylinder block 11 is covered by a cylinder head 14. In the cylinder head 14, intake ports 15 and exhaust ports 16 are provided. The intake ports 15 and the exhaust ports 16 are connected to the respective cylinder bores 13. An intake valve 17 is provided in each intake port 15. An exhaust valve 18 is provided in each exhaust port 16.

In the cylinder head 14, an ignition plug 19 for spark ignition is disposed at a substantially center position in a top surface of a combustion chamber. An injector 20 is provided for the intake port 15. An ECU 21 controls fuel injection from the injector 20. The ECU 21 receives signals from sensors (not shown). For example, the ECU 21 receives signals from temperature sensors that measure an ambient temperature and an engine coolant temperature, a signal from a crank angle detection sensor, and a signal from a timer that measures an elapsed time after the internal combustion engine is stopped.

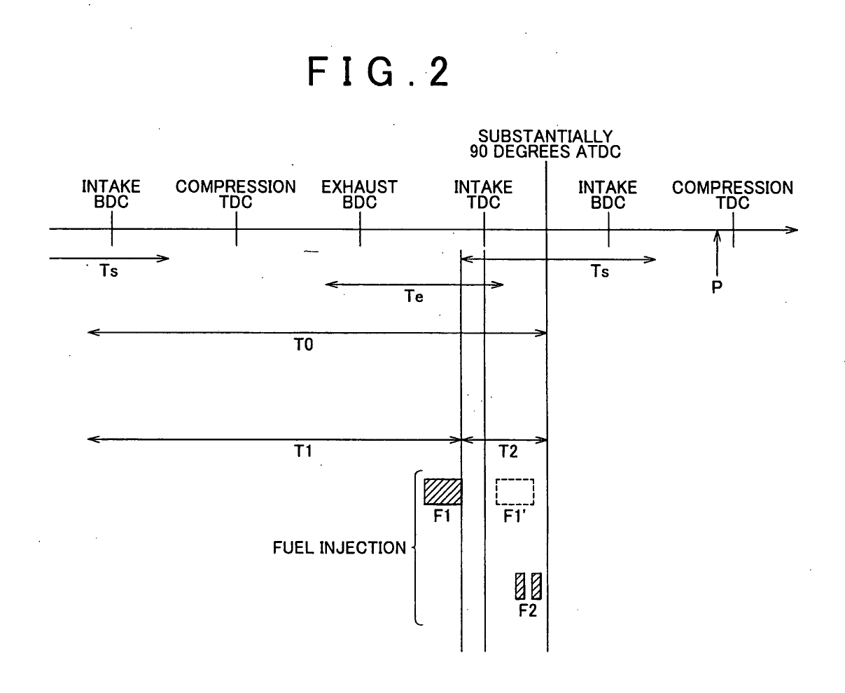

Next, the principle of a fuel injection control process in the embodiment will be described with reference to FIG. 2. FIG. 2 is a timing chart showing fuel injection timings when the internal combustion engine is restarted after the internal combustion engine is stopped by the idling stop control.

FIG. 2 shows an intake period Ts in which the intake valve 17 is open, and an exhaust period Te in which the exhaust valve 18 is open. As generally known, the intake period Ts is a period from a point before a top dead center (TDC) of an intake stroke to a point after a bottom dead center (BDC) of the intake stroke. The exhaust period Te is a period from a point before BDC of an exhaust stroke to a point after TDC of the intake stroke. In FIG. 2, an ignition timing P is a target ignition timing at a time of restart of the internal combustion engine. Fuel needs to be injected into the intake port 15 from the injector 20 by substantially 90 degrees after the top dead center of the intake stroke (i.e., in a period T0) to perform ignition at the ignition timing P.

For example, in a case where the piston 12 is stopped at a point in a period T1 before an opening timing of the intake valve 17 when the internal combustion engine is stopped, the fuel can be injected in a fuel injection period F1 immediately before the opening timing of the intake valve 17. In this case, when a crankshaft is rotated at the time of restart of the internal combustion engine, the air, which has been mixed with the fuel in the intake port 15, is taken into the cylinder. Therefore, a degree of homogeneity of air-fuel mixture is maintained at a sufficiently high level. Also, in this case, because at least part of an exhaust stroke is performed during a period after the start of the rotation of the crankshaft until the ignition timing P, high-temperature air in the cylinder is discharged, and low-temperature air in a surge tank is supplied into the cylinder.

That is, in the case where the piston 12 is stopped at a point in the period T1 when the internal combustion engine is stopped, if the fuel is injected once in the fuel injection period F1, ignition is performed under the condition that the degree of homogeneity of the air-fuel mixture is sufficiently high, and a temperature in the cylinder is relatively low. Therefore, abnormal combustion is not caused.

In a case where the piston 12 is stopped at a point in a period T2 after the opening timing of the intake valve 17 until substantially 90 degrees after a top dead center (ATDC) of the intake stroke when the internal combustion engine is stopped, the fuel needs to be injected at the substantially same timing as the timing at which the rotation of the crankshaft starts. In this case, if the fuel is injected once in the period T2 (i.e., in a fuel injection period F1′) in a manner similar to the manner in the case where the piston 12 is stopped at a point in the period T1 when the internal combustion engine is stopped, abnormal combustion is caused.

That is, in the case where the piston 12 is stopped at a point in the period T2 when the internal combustion engine is stopped, almost no exhaust stroke is performed during a period after the start of the rotation of the crankshaft until the ignition timing P. Therefore, if much time has not elapsed after the internal combustion engine is stopped, the air, which has been heated by the high coolant temperature and the high ambient temperature, remains in the cylinder. Therefore, the combustion is performed in the high temperature condition. Further, in this case, because the fuel is injected during the intake stroke, the degree of homogeneity of the air-fuel mixture decreases. That is, in the case where the piston 12 is stopped at a point in the period T2 when the internal combustion engine is stopped, if the fuel is injected once in the fuel injection period F1′, the air-fuel mixture with the low degree of homogeneity is combusted in the high temperature condition. Therefore, there is a high possibility that abnormal combustion may be caused.

Accordingly, in the embodiment, in the case where the piston 12 is stopped at a point in the period T2 when the internal combustion engine is stopped, the fuel is injected a plurality of times (i.e., multiple injections are performed) in fuel injection periods F2 in the period T2. This increases the degree of homogeneity of the air-fuel mixture, and reduces the possibility of occurrence of abnormal combustion.

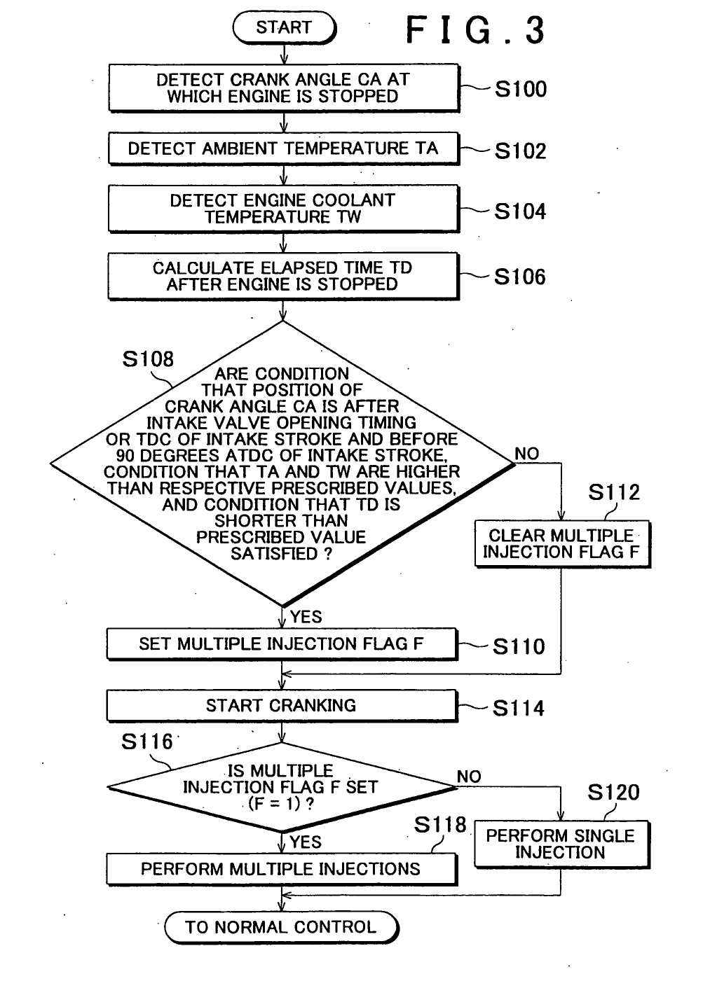

Next, a flow of the fuel injection control process in the embodiment will be described with reference to a flowchart in FIG. 3. The ECU 21 executes the fuel injection control process shown in FIG. 3 when a restart condition is satisfied after the internal combustion engine is stopped by the idling stop control. The restart condition may be satisfied; for example, when it is detected that a brake is released.

In step S100, a crank angle CA at which the internal combustion engine is stopped is detected. In step S102, an ambient temperature TA is detected. In step S104, an engine coolant temperature TW is detected. In step S106, an elapsed time TD after the internal combustion engine is stopped is detected.

In step S108, it is determined whether the multiple injections need to be performed for each cylinder. More specifically, it is determined whether the position of the detected crank angle is after the opening timing of the intake valve or TDC of the intake stroke, and before 90 degrees ATDC of the intake stroke in each cylinder. Further, for example, it is determined whether the ambient temperature TA and the engine coolant temperature TW are higher than respective prescribed values, and whether the elapsed time TD after the internal combustion engine is stopped is shorter than a prescribed value. Thus, it is estimated whether the temperature of the air-fuel mixture in the cylinders at the time of restart of the internal combustion engine is high enough to require the multiple injections.

That is, in step 108, it is determined whether a condition (i) that the position of the detected crank angle is after the opening timing of the intake valve or TDC of the intake stroke, and before 90 degrees ATDC of the intake stroke, a condition (ii) that the ambient temperature TA and the engine coolant temperature TW are higher than the respective prescribed values, and a condition (iii) that the elapsed time TD after the internal combustion engine is stopped is shorter than the prescribed value are all satisfied for each cylinder. A multiple injection flag F for the cylinder, for which all the conditions (i), (ii), and (iii) are determined to be satisfied in step S108, is set (F=1) in step S110. A multiple injection flag F for the cylinder, for which at least one of the conditions (i), (ii), and (iii) is determined to be unsatisfied in step S108, is cleared (F=0) in step S112.

In step S114, cranking is started. In step S116, it is determined whether the multiple injection flag F for each cylinder is set. Multiple injections are performed for the cylinder for which the multiple injection flag F is set (F=1), in step S118. A single injection is performed for the cylinder for which the multiple injection flag F is not set (F=0), in step S120.

Thus, the ECU 21 ends the fuel injection control process in the embodiment, and returns to a normal control.

As described above, in the embodiment, the degree of homogeneity of the air-fuel mixture in each cylinder is maintained at a high level at any crank angle. Therefore, it is possible to reduce the possibility of occurrence of abnormal combustion in the case where the internal combustion engine is stopped and restarted at a short interval, and ignition needs to be performed quickly in the high temperature condition, as in the vehicle that has the idling stop function.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A fuel injection control system for an ignition-spark internal combustion engine, characterized in that
when a piston in a cylinder is stopped at a point after an opening timing of an intake valve, and before substantially 90 degrees after a top dead center of an intake stroke at a time of start of the internal combustion engine, fuel is injected for the cylinder a plurality of times during a period from the opening timing of the intake valve to substantially 90 degrees after the top dead center of the intake stroke.

2. The fuel injection control system according to claim 1, wherein when the piston in the cylinder is stopped at a point after the opening timing of the intake valve, and before substantially 90 degrees after the top dead center of the intake stroke at the time of start of the internal combustion engine, and it is estimated that a temperature in the cylinder is higher than a prescribed value, the fuel is injected for the cylinder a plurality of times.

3. The fuel injection control system according to claim 2, wherein:
the internal combustion engine is controlled by an idling stop function; and
it is estimated whether the temperature in the cylinder is higher than the prescribed value, using an elapsed time after the internal combustion engine is stopped until a restart condition is satisfied.

4. The fuel injection control system according to claim 3, wherein it is estimated whether the temperature in the cylinder is higher than the prescribed value, using the elapsed time, an ambient temperature, and an engine coolant temperature.

5. The fuel injection control system according to any one of claims 1 to 4, wherein the fuel is injected to an intake port.

6. A fuel injection control system for an ignition-spark internal combustion engine, characterized by comprising:
a stop point determination portion that determines whether a piston in a cylinder is stopped at a point after an opening timing of an intake valve, and before substantially 90 degrees after a top dead center of an intake stroke at a time of start of the internal combustion engine; and
a fuel injection control portion that executes a fuel injection control so that fuel is injected for the cylinder a plurality of times, when the stop point determination portion determines that the piston in the cylinder is stopped at a point after the opening timing of the intake valve, and before substantially 90 degrees after the top dead center of the intake stroke at the time of start of the internal combustion engine.

7. The fuel injection control system according to claim 6, wherein the fuel injection control portion executes the fuel injection control so that the fuel is injected for the cylinder a plurality of times during a period from the opening timing of the intake valve to substantially 90 degrees after the top dead center of the intake stroke, when the stop point determination portion determines that the piston in the cylinder is stopped at a point after the opening timing of the intake valve, and before substantially 90 degrees after the top dead center of the intake stroke at the time of start of the internal combustion engine.

8. The fuel injection control system according to claim 6 or 7, characterized by further comprising
an in-cylinder temperature estimation portion that estimates whether a temperature in the cylinder is higher than a prescribed value, wherein when the stop point determination portion determines that the piston in the cylinder is stopped at a point after the opening timing of the intake valve, and before substantially 90 degrees after the top dead center of the intake stroke at the time of start of the internal combustion engine, and the in-cylinder temperature estimation portion estimates that the temperature in the cylinder is higher than the prescribed value, the fuel injection control portion executes the fuel injection control so that the fuel is injected for the cylinder a plurality of times.

9. The fuel injection control system according to claim 8, wherein:
the internal combustion engine is controlled by an idling stop function; and
the in-cylinder temperature estimation portion estimates the temperature in the cylinder using an elapsed time after the internal combustion engine is stopped until a restart condition is satisfied.

10. The fuel injection control system according to claim 9, wherein the in-cylinder temperature estimation portion estimates whether the temperature in the cylinder is higher than the prescribed value, using the elapsed time, an ambient temperature, and an engine coolant temperature.

11. The fuel injection control system according to any one of claims 6 to 10, wherein the fuel is injected to an intake port.

12. A fuel injection control method for an ignition-spark internal combustion engine, characterized by comprising:
determining whether a piston in a cylinder is stopped at a point after an opening timing of an intake valve, and before substantially 90 degrees after a top dead center of an intake stroke at a time of start of the internal combustion engine; and
executing a fuel injection control so that fuel is injected for the cylinder a plurality of times, when it is determined that the piston in the cylinder is stopped at a point after the opening timing of the intake valve, and before substantially 90 degrees after the top dead center of the intake stroke at the time of start of the internal combustion engine.

13. The fuel injection control method according to claim 12, wherein when it is determined that the piston in the cylinder is stopped at a point after the opening timing of the intake valve, and before substantially 90 degrees after the top dead center of the intake stroke at the time of start of the internal combustion engine, the fuel injection control is executed so that the fuel is injected for the cylinder a plurality of times during a period from the opening timing of the intake valve to substantially 90 degrees after the top dead center of the intake stroke.

14. The fuel injection control method according to claim 12 or 13, characterized by further comprising
estimating whether a temperature in the cylinder is higher than a prescribed value, wherein when it is determined that the piston in the cylinder is stopped at a point after the opening timing of the intake valve, and before substantially 90 degrees after the top dead center of the intake stroke at the time of start of the internal combustion engine, and it is estimated that the temperature in the cylinder is higher than the prescribed value, the fuel injection control is executed so that the fuel is injected for the cylinder a plurality of times.

15. The fuel injection control system according to claim 14, wherein:
the internal combustion engine is controlled by an idling stop function; and
it is estimated whether the temperature in the cylinder is higher than the prescribed value, using an elapsed time after the internal combustion engine is stopped until a restart condition is satisfied.

16. The fuel injection control method according to claim 15, wherein it is estimated whether the temperature in the cylinder is higher than the prescribed value, using the elapsed time, an ambient temperature, and an engine coolant temperature.

17. The fuel injection control method according to any one of claims 12 to 16, wherein the fuel is injected to an intake port.
